(19) United States
(12) Patent Application Publication
(10) Pub. No.: US 2024/0060240 A1
(43) Pub. Date: Feb. 22, 2024

(54) METHOD AND DEVICE FOR PRODUCING A DECORATIVE PAPER, AND OBJECT HAVING SUCH A DECORATIVE PAPER

(71) Applicant: SWISS KRONO Tec AG, Luzem (CH)

(72) Inventors: Torsten KOPP, Ruhner Berge (DE); Norbert KALWA, Horn-Bad Meinberg (DE)

(21) Appl. No.: 18/269,707

(22) PCT Filed: Jan. 13, 2022
(86) PCT No.: PCT/EP2022/050689

§ 371 Date: Jun. 26, 2023

(30) Foreign Application Priority Data
Jan. 15, 2021 (EP) 21151856.8

(51) Int. Cl. D21H 19/68; D21H 19/82; D21H 27/18; B41M 5/00; B41J 11/00; B44C 3/02

(52) U.S. Cl. CPC D21H 19/68; D21H 19/82; D21H 27/18; B41M 5/0017; B41J 11/0015; B44C 3/02

(57) ABSTRACT

The disclosure relates to a method for producing a decorative paper by a digital printing machine, wherein the method comprises the following steps: a. providing at least one base stock; b. printing a surface of the base stock with a primer, so as to result in a printed base stock; c. printing the surface of the printed base stock with at least one printing ink by means of the digital printing machine, wherein, at at least one location, the surface of the base stock is not printed with the primer or with the printing ink.

### FIELD OF INVENTION

The invention relates to a method for producing a decorative paper by means of a digital printing facility, the method comprising the following steps: a. providing at least one base paper, b. printing a primer onto a surface of the base paper so that a printed base paper is obtained, c. printing at least one printing ink onto the surface of the printed base paper by means of a digital printing facility. The invention also relates to an object with a base body with a decorative paper that is or can be produced in this way arranged on at least one of its surfaces.

### BACKGROUND OF INVENTION

Nowadays, decoration is printed onto the surface of paper in a range of applications and for various purposes. In the present case, a decoration is understood in particular to mean a graphic, especially a pictorial, representation with which should change the visual impression made by the paper. The paper may be provided in the form of individual sheets or in the form of a roll. If the paper is printed in the form of a roll, it is preferably formatted or clipped to the correct size required for the application after printing. Typically, the printed paper usually but not necessarily is impregnated, painted or otherwise processed before being formatted.

The use of a digital printing facility for printing onto the surface of a paper, in particular a base paper, has a number of advantages. For example, it is very quick and easy to switch from one decoration to another. There is no need to remove or exchange any rollers or similar elements, meaning that conversion times are very short.

Digital printing has therefore become considerably more important in the industrial production of decorative surfaces. Previously deployed printing processes, such as screen printing or gravure printing have been at least partially replaced, or almost completely in some fields and for some applications. In almost all areas, digital printing is now used to produce enhanced decorative surfaces. This applies not only to classic print media and the advertising industry but also, for example, to producers of floor coverings, tiles, furniture and/or laminate panels that can be used as wall covering, ceiling covering or floor covering, for example. The particular advantages of digital printing, such as the reduction in cost for printing rollers, the reduction in possible batch sizes, the simple adjustment and amendment of colors and shades as well as the wider range of available decorations and the switching from one decoration to another, have accelerated this development.

Particularly in the production of laminate panels, which are preferably used as wall cladding, ceiling cladding or flooring, a qualitatively flawless print image and high print quality are of crucial importance for sales. The design and properties of the surface of the object to be printed using digital printing may pose a problem in the process. For example, there are designs of the base paper to be printed that absorb an applied printing ink and are as such are unable to produce a flawless printed image. This applies, for example, to certain designs of wood-based materials coated in a color. In this case, the applied printing ink may be absorbed into the substrate to be printed, leading to so-called “missing dots”. As a result, the print is no longer as striking as desired, and a significant advantage of digital printing is lost. The smaller the amount of printing ink applied, the more pronounced this problem becomes. Since digital printing works with a relatively small amount of printing ink per surface unit, this is a particularly big problem in this case. The amount used is usually around 5 g/m² to 10 g/m².

As such, various approaches to tackling this problem are known from the prior art. For example, EP 2 158 358 B1 proposes applying a color-receiving layer, i.e., a primer, to the surface to be printed before applying the printing ink and the actual decoration. However, it is disadvantageous that this leads to higher costs due to the resulting additional process step. Moreover, an additional layer of primer has to be applied, which also incurs higher costs. A further disadvantage is the fact that the color of the primer must be adjusted to the color of the base paper to be printed, as devia-tions in color may otherwise emerge during subsequent printing with the printing ink. Due to the primer, which is applied to the paper before the printing ink, the paper is sealed from one side, so that the absorption and penetration of the printing ink into the paper is at least partially, but preferably completely, prevented. However, this may cause difficulties in subsequent process steps, for example when impregnating the paper to be printed with a synthetic resin, such as a melamine resin. This may lead to an uneven impregnation or impregnates that are prone to rolling up.

### SUMMARY

The invention is therefore based on the task of eliminating or at least reducing the disadvantages of the prior art.

The invention solves the addressed task by way of a method according to the pream-ble of claim 1, characterized in that neither the primer nor the printing ink is printed onto the surface of the base paper at at least one point.

In the method according to the invention, a primer is printed onto the base paper provided, said primer also serving to receive the color. As a result, the properties of the surface of the base paper to be printed are adapted and improved for printing. The actual decoration is then produced by printing onto the surface of the base paper to be printed with the printing ink. The decoration is usually a graphic or pictorial representation with a format that is preferably adjusted to the format of the base paper in at least one direction, but preferably in two directions perpendicular to each other. Particularly preferably, the dimensions of the decoration are adjusted to the dimensions of the base paper in both length and width. The format or also the area or surface area of the decoration results from these dimensions. The entire surface of this area of the decoration is not printed during digital printing. Rather, the resulting image is made up of a plurality of image points arranged next to each other with spaces between them in which no printing ink is applied to the surface to be printed, i.e., in the present case the surface of the base paper onto which the primer is printed. The invention is based on the knowledge that it is therefore not necessary to adjust the surface properties of the base paper at the points where no printing ink is applied to the surface to be printed. There is therefore at least one point on the surface to be printed that is also not printed with a primer. Hence at this point, there is neither primer nor the applied printing ink.

It is therefore possible to reduce the amount of primer applied. The more points at which no printing ink or primer is applied to the surface of the base paper to be printed, the smaller the amount of primer used and thus the greater the reduction in costs.

Preferably, the primer is printed onto the surface of the base paper using a digital printing facility, preferably the digital printing facility that is used to print the printing ink onto the base paper. This reduces the amount of equipment required for the process since printing the primer onto the surface of the base paper does not require a separate device. If only one digital printing facility is used to print the primer onto the base paper and to print the printing ink onto the base paper, it preferably features multiple printing heads that are, particularly preferably, arranged one behind the other in the direction of the process. This ensures that at least a first printing head is used to print the primer onto the surface of the base paper and at least a second printing head is used to print the printing ink onto the surface of the resulting printed base paper.

Preferably, printing ink is only printed onto the surface of the printed base paper at points where primer has been printed beforehand. This ensures that the surface properties of the area onto which printing ink is to be printed are adjusted to the print, so that the same printing quality can be achieved everywhere. In other words, printing ink is not directly applied to a surface of the base paper where there is no primer. In this case, the total area of the base paper onto which the primer is printed is preferably larger than the total area of the printed base paper onto which the printing ink is printed. This means that there may well be points on the surface of the base paper onto which a primer, but not a printing ink, has been printed.

In a preferred embodiment, the primer is only printed onto the surface of the base paper at the points where the printing ink is also applied. This ensures that as little primer as possible, but particularly preferably no primer at all, is wasted. It is therefore possible to save large amounts of primer.

Advantageously, the same template is used to print the primer onto the surface of the base paper and to print the printing ink onto the surface of the printed base paper. A digital printing facility requires control signals provided by an electric control unit, preferably an electronic data processing device, to control the digital printing facility and thus to determine which printing ink and/or which primer should be applied at which point. In all of the embodiments described here, the printing ink can of course be multi-colored, so that ink of different colors can be used to produce a multi-colored print, as is known from the prior art. To generate the control signals, the electric control unit preferably accesses a digital template of the decoration to be printed, which is preferably stored in an electronic memory that can be accessed by the electric control unit. The memory can be part of the digital printing facility or a separate ele-ment that can communicate with the digital printing facility and particularly its electric control unit. If one digital printing facility, preferably the same digital printing facility, is now used to print both the printing ink onto the surface of the printed base paper and the primer onto the surface of the base paper, control signals must be generated for each case. These are preferably determined from the same template, wherein the control signals for printing on the primer and printing on the printing ink may be iden-tical or different. The electric control unit is preferably configured to determine both the control signals for printing with the printing ink and the control signals for printing with the primer from the template.

In a preferred embodiment, the primer is printed onto at most 55%, preferably at most 45%, especially preferably at most 35%, of the surface of the base paper.

Preferably, the method comprises a further step in which the base paper onto which the printing ink has been printed is impregnated with at least one synthetic resin, preferably a melamine resin. This is necessary for further processing and/or the use of the decorative paper if, for example, it is laminated onto a surface of an object, such as a wood-based material panel, to produce, for example, a laminate panel.

The present invention also solves the addressed task by way of a device for producing a decorative paper that comprises at least one digital printing facility for printing a primer and at least one printing ink onto a surface of a base paper, and an electric control unit, especially an electric data processing device that is configured to carry out a method of the type described here. The electric control unit is preferably configured to generate a template for printing the primer onto the base paper from a template for printing the at least one printing ink onto the printed base paper. This is also understood to mean that the control signals for the various printing heads used for printing with the printing ink and printing with the primer are generated from a digital template.

The electric control unit is preferably configured to determine a digital template from an image, such as a scan or a photo, usually provided in the form of an RGB file, said template preferably being provided in a so-called CMYK format. A “Raster Imaging Process” software is preferably used during this conversion that transmits the color values of the image, provided for example in the colors red, yellow and green, into color values that can be generated by the digital printing facility. These are usually cyan, magenta, yellow and black, which is represented by the letter combination CMYK. In addition to this template, a file can also be generated that contains all points to be printed with ink, irrespective of which printing ink, i.e., of which color, is to be used to print the respective point. This template can then be used to determine control signals that are used to print primer onto the surface of the base paper.

The invention also solves the addressed task by way of an object with a base body, a decorative paper being arranged on at least one surface of the object, wherein said paper can be or is preferably produced according to one of the methods described here.

### BREIF DESCRIPTION OF DRAWINGS

In the following, an embodiment example of the invention will be explained in more detail with the aid of the accompanying figure. It shows:

FIG. 1 is a schematic representation of a device for executing the invention.

### DETAILED DESCRIPTION

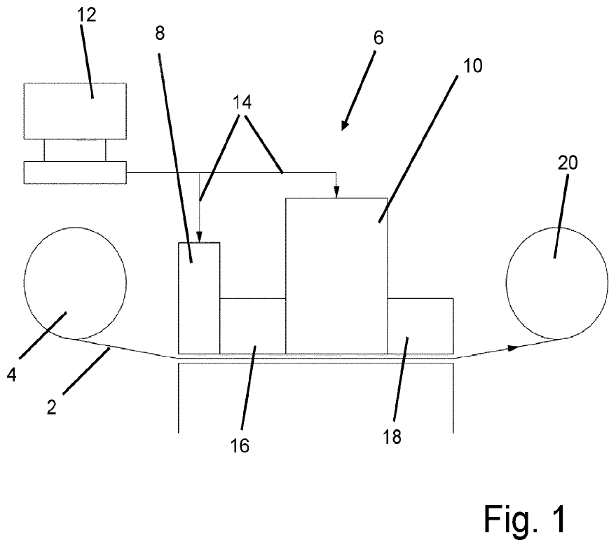

FIG. 1 depicts a schematic sectional view through a device for executing the invention. Base paper 2 is supplied in the left-hand area of the device depicted. In the embodiment example shown, it is supplied on a roller 4. It enters a digital printing facility 6 which comprises a first printing unit 8 and a second printing unit 10. The first printing unit 8 and the second printing unit 10 can each have multiple printing heads or be designed with just one printing head.

The device comprises an electric control unit 12 in the form of an electronic data processing device that is connected to both the first print unit 8 and the second print unit by means of data lines 14. Control signals are generated in the electric control unit 12 to control the first print unit 8 and the second print unit 10, said signals being transmitted to the respective print unit 8, 10 via the data lines 14.

A primer is applied to the base paper 2 by means of the first print unit 8. However, it is not spread across the entire surface of the base paper 2; rather, it is printed onto the surface of the base paper 2 in such a way that no primer reaches the surface at at least one point. No printing ink is applied to this point during the rest of the method.

Once the primer has been applied to the base paper 2 by the first print unit 8, it enters a first dryer 16, in which the base paper 2 and the applied primer are dried to a predetermined remaining moisture or according to a predetermined drying process. Here, the drying time and/or a drying temperature are preferably predetermined.

The base paper 2 printed and dried in this way then reaches the second print unit 10, in which printing ink is printed onto the surface of the base paper 2. This creates the actual decoration. The paper printed in this way is subsequently dried in a second dryer 18 and then wound up on another roller 20 to be transported and further processed.

1. A method for producing a decorative paper by a digital printing facility, the method comprising:
a. providing at least one base paper,
b. printing a primer onto a surface of the base paper so that a printed base paper is obtained,
c. printing at least one printing ink onto the surface of the printed base paper by a digital printing facility,
wherein neither the primer nor the printing ink is printed onto the surface of the base paper at at least one point.

2. The method according to claim 1, wherein the primer is printed onto the surface of the base paper using the digital printing facility.

3. The method according to claim 1, wherein the printing ink is only printed onto the surface of the printed base paper at points where the primer has been printed beforehand, wherein an area of the base paper onto which the primer is printed is larger than the area of the printed base paper onto which the printing ink is printed.

4. The method according to claim 1, wherein the primer is only printed onto the surface of the base paper at points where the printing ink is also applied.

5. The method according to claim 1, the further comprising a same template being used to print the primer onto the surface of the base paper and to print the printing ink onto the surface of the printed base paper.

6. The method according to claim 1, wherein the primer is printed onto at most 55%, of the surface of the base paper.

7. The method according to claim 1, further comprising:
d. impregnating the base paper onto which the printing ink has been printed with at least one synthetic resin.

8. A device for producing a decorative paper, wherein the device has at least one digital printing facility for printing a primer and at least one printing ink onto a surface of a base paper, and an electrical control unit configured to carry out a method according to claim 1.

9. The device according to claim 8, wherein the electrical control unit is configured to generate a template for printing the primer onto the base paper from a template for printing the at least one printing ink onto a printed base paper.

10. An object with a base body, wherein a decorative paper is produced according to claim 1 is arranged on at least one of the surfaces of the object.

11. The method according to claim 2, wherein the digital printing facility is also used to print the printing ink onto the base paper.

12. The method according to claim 6, wherein the primer is printed onto at most 45% of the surface of the base paper.

13. The method according to claim 12, wherein the primer is printed onto at most 35% of the surface of the base paper.

14. The method according to claim 7, wherein the at least one synthetic resin comprises a melamine resin.

15. The method of claim 1, wherein the ink and the primer are printed by the printing facility.
